(19) United States
(12) Patent Application Publication
(10) Pub. No.: US 2012/0094062 A1
(43) Pub. Date: Apr. 19, 2012

(54) AEROGEL, COMPOSITION FOR PREPARING THE AEROGEL, AEROGEL COMPOSITE, AND METHOD OF MAKING THE SAME

(75) Inventors: Sang-Ho PARK, Seoul (KR); Myung Dong CHO, Hwaseong-si (KR); Kwang-Hee KIM, Seoul (KR); Sung-Woo HWANG, Yongin-si (KR)

(73) Assignee: SAMSUNG ELECTRONICS CO., LTD., Suwon-si (KR)

(21) Appl. No.: 13/164,418

(22) Filed: Jun. 20, 2011

(30) Foreign Application Priority Data
Oct. 15, 2010 (KR) 10-2010-0101088

(51) Int. Cl. B32B 3/12; B05D 3/00; C08J 9/28; C08G 12/32; B32B 3/26

(52) U.S. Cl. 428/117; 521/187; 428/304.4; 442/1; 428/219; 521/64; 427/384

(57) ABSTRACT

An aerogel comprising a polymerizing product of an alkylated melamine-formaldehyde copolymer, or of an alkylated melamine-formaldehyde copolymer and an aryl compound substituted with at least one hydroxyl group.

### CROSS-REFERENCE TO RELATED APPLICATION

This application claims priority to Korean Patent Application No. 10-2010-0101088, filed on Oct. 15, 2010, and all the benefits accruing therefrom under 35 U.S.C. §119, the content of which in its entirety is herein incorporated by reference.

### BACKGROUND

1. Field

This disclosure relates to an aerogel, a composition for preparing an aerogel, an aerogel composite, a method of manufacturing the aerogel, and a method of manufacturing the aerogel composite.

2. Description of the Related Art

An aerogel is a mesoporous material having a nanometer-sized three-dimensional mesh structure. Aerogels have adiabatic and sound absorption properties, which makes them useful in a variety of diverse areas. In particular, aerogels may be utilized in a cooling device such as a refrigerator and a freezer, used as an adiabatic material in aerospace industry applications, and used in building construction.

Aerogels may be categorized as an inorganic aerogel or an organic aerogel according to the material of the aerogel. An example of an inorganic aerogel is a silica aerogel. An organic aerogel includes an organic linking group therein, and thus is typically more flexible than an inorganic aerogel. An organic aerogel may have various properties depending on its chemical structure and the manufacturing process used to produce the aerogel. There remains a need in the art however, for organic aerogels having improved properties.

### BRIEF SUMMARY OF THE INVENTION

An embodiment of this disclosure provides an aerogel having improved properties.

Another embodiment of this disclosure provides an aerogel composition for preparing the aerogel.

Yet another embodiment of this disclosure provides an aerogel composite having improved properties.

Still another embodiment of this disclosure provides a method of manufacturing the aerogel.

Another embodiment of this disclosure provides a method of manufacturing the aerogel composite.

According to an embodiment of this disclosure, an aerogel is provided that includes a polymerization product of an alkylated melamine-formaldehyde copolymer; or a polymerization product of an alkylated melamine-formaldehyde copolymer and an aryl compound substituted with at least one hydroxyl group.

According to another embodiment of this disclosure, a composition for preparing an aerogel is provided that includes an alkylated melamine-formaldehyde copolymer; or an alkylated melamine-formaldehyde copolymer and an aryl compound substituted with at least one hydroxyl group.

The alkylated melamine-formaldehyde copolymer may include a repeating unit represented by the following Chemical Formula 1.

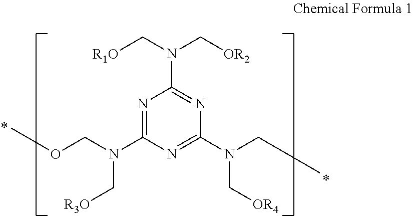

In Chemical Formula 1,

R₁ to R₄ are each independently hydrogen or an alkyl group, and at least one of R₁ to R₄ is an alkyl group.

The alkyl group may be a C1 to C10 linear or branched alkyl group.

The alkylated melamine-formaldehyde copolymer may have a number average molecular weight of about 10 Daltons to about 1000 Daltons.

The alkylated melamine-formaldehyde copolymer and aryl compound substituted with at least one hydroxyl group may be polymerized at a weight ratio of about 1:0.01 to about 1:0.5. The alkylated melamine-formaldehyde copolymer and aryl compound substituted with at least one hydroxyl group may be polymerized at a weight ratio of about 1:0.05 to about 1:0.5.

The aerogel may be prepared by polymerizing a composition for preparing an aerogel that includes an alkylated melamine-formaldehyde copolymer, or an alkylated melamine-formaldehyde copolymer and an aryl compound substituted with at least one hydroxyl group, in an organic solvent; and removing the solvent to form the aerogel.

According to another embodiment of this disclosure, an aerogel composite is provided that includes a support including a plurality of micro-openings, and aerogel disposed in the micro-openings.

The support may include an aerogel derived from a polymer selected from polyurethane, polyvinylchloride, polycarbonate, polyester, polymethyl(meth)acrylate, polyurea, polyether, polyisocyanurate, a melamine-formaldehyde copolymer, and a combination thereof. The polymer may include a melamine-formaldehyde copolymer.

The micro-openings may have a size of less than about 300 micrometers (μm).

The support may have a two-dimensional honeycomb or a three-dimensional mesh structure.

The support may have an expansion ratio or a shrinkage ratio of about 10% or less when being contacted with a solvent.

The aerogel or aerogel composite may have a density of about 0.2 grams per cubic centimeter (g/cm³) or less.

The aerogel or aerogel composite may have porosity of about 90% or more by volume.

The aerogel or aerogel composite may have a compression strength of about 10 megaPascal (MPa) or more.

In another embodiment, the aerogel composite may be manufactured in accordance with a method that includes providing a support including a plurality of micro-openings, disposing a composition for producing an aerogel in the support, wherein the composition comprises an organic solvent, polymerizing the disposed composition for producing an aerogel, and removing the organic solvent to provide the aerogel composite.

The organic solvent may be removed by performing atmospheric pressure drying, supercritical drying, or a combination thereof.

### BRIEF DESCRIPTION OF THE DRAWINGS

The above and other aspects, advantages and features of this disclosure will become more apparent by describing in further detail embodiments thereof with reference to the accompanying drawings, in which:

FIG. 1 is a schematic diagram of an aerogel composite according to an embodiment.

FIG. 2 is a schematic diagram sequentially illustrating an embodiment of a manufacturing method of an aerogel composite.

FIGS. 3A and 3B are optical microscope photographs of the aerogel composites according to Examples 8 and 9.

FIG. 3C is an optical microscope photograph of a support that is used in the Examples herein.

FIG. 4A is a graph illustrating a nitrogen (N₂) adsorption-desorption isotherm of an aerogel composite according to Example 9.

FIG. 4B is a graph illustrating a pore distribution calculated from the nitrogen adsorption-desorption isotherm of the aerogel composite according to Example 9.

FIG. 5A is a graph illustrating a nitrogen (N₂) adsorption-desorption isotherm of an aerogel composite according to Example 10.

FIG. 5B is a graph illustrating a pore distribution calculated from a nitrogen (N₂) adsorption-desorption isotherm of the aerogel composite according to Example 10.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

An “alkyl” group as used herein is a straight or branched chain saturated aliphatic hydrocarbyl group having, for example 1 to 20, 1 to 10, or 1 to 5 carbon atoms.

An “aryl” group as used herein is a carbocyclic ring system that includes one or more aromatic rings in which all ring members are carbon, having for example 6 to 30, 6 to 18, or 6 to 10 carbon atoms. Aryl groups may be optionally substituted with one or more substituents selected from a C1 to C6 alkyl, C2 to C6 alkenyl, C2 to C6 alkynyl, or C6 to C10 aryl. More than one ring may be present, and any additional rings may be independently aromatic, saturated, or partially unsaturated and multiple rings, if present, may be fused, pendent, spirocyclic or a combination thereof. Non-limiting examples include phenyl, naphthyl, and tetrahydronaphthyl groups.

“Polymerization,” and “polymerizing” as used herein is refers to the formation of a polymer from monomers, the formation of a polymer from oligomers, the cross-linking of a polymer with a multifunctional agent, or a combination of any of the foregoing processes.

According to an embodiment, an aerogel includes a cross-linked polymer obtained by polymerization of an alkylated melamine-formaldehyde copolymer, or by polymerization of an alkylated melamine-formaldehyde copolymer and an aryl compound substituted with at least one hydroxyl group.

The alkylated melamine-formaldehyde copolymer may include a repeating unit represented by the following Chemical Formula 1.

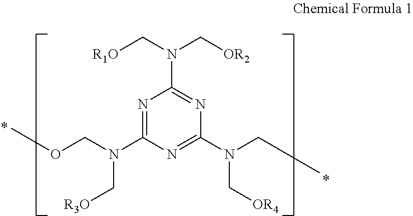

In Chemical Formula 1,

R₁ to R₄ are each independently hydrogen or an alkyl group wherein at least one of R₁ to R₄ is an alkyl group, and “*” represents a point of attachment of each repeat unit.

The alkyl group may be a C1 to C10 linear or branched alkyl group, for example, a methyl group, an n-butyl group, or an isobutyl group.

The alkylated melamine-formaldehyde copolymer may be prepared by polymerizing melamine, formaldehyde, and alkyl alcohol. The alkyl alcohol may be a C1 to C10 linear or branched alcohol, for example, methanol, n-butanol, or isobutanol. Herein, water is used as a solvent during the polymerization reaction. A commercially manufactured alkylated melamine-formaldehyde copolymer may also be used.

The alkylated melamine-formaldehyde copolymer may have a number average molecular weight of about 10 Daltons to about 1000 Daltons, specifically about 50 Daltons to about 800 Daltons, more specifically about 100 Daltons to about 500 Daltons. When the alkylated melamine-formaldehyde copolymer has a number average molecular weight within this range, the copolymer may have excellent solubility in an organic solvent.

The cross-linking polymerization reaction of the alkylated melamine-formaldehyde copolymer and the aryl compound substituted with at least one hydroxyl group is shown in the following Reaction Scheme 1. Also as shown in Reaction Scheme 1, the reaction produces a polymer comprising units as shown in Chemical Formula 2.

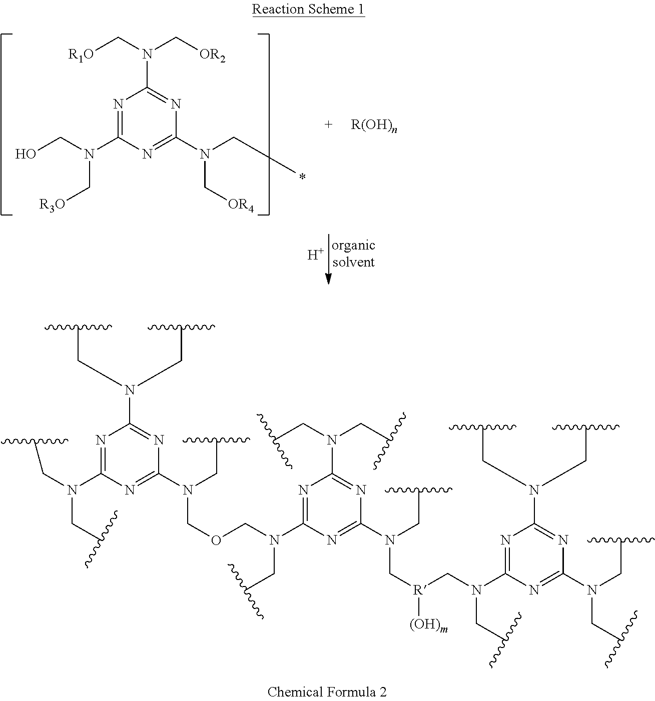

In Reaction Scheme 1,

R₁ to R₄ and “*” are defined the same as in Chemical Formula 1,

R is a C6 to C30 aryl group,

R′ is a C6 to C30 aryl group or a C6 to C30 aryloxy group,

n is an integer of 1 or more, and m is an integer of 1 or more and may be the same as or less than n.

In an embodiment, n is an integer of 1 to 4, specifically 1 to 3, more specifically 1 to 2, and m is an integer of 0 to 4, specifically 0 to 3, more specifically 0 to 2.

Examples of the aryl compound substituted with at least one hydroxyl group may include at least one selected from a dihydroxybenzene substituted with 0-3 C1 to C3 alkyl groups, such as resorcinol (1,3-dihydroxybenzene) and catechol (1,2-dihydroxybenzene), phenol, a phenol substituted with 0-3 C1 to C3 alkyl groups such as o-, m, or p-cresol, a trihydroxy benzene substituted with 0-3 C1 to C3 alkyl groups such as phloroglucinol (1,3,5-trihydroxybenzene), or a polyphenol. A combination of different aryl compounds substituted with at least one hydroxyl group can be used.

The alkylated melamine-formaldehyde copolymer and aryl compound substituted with at least one hydroxyl group may be polymerized at a weight ratio of about 1:0.01 to about 1:5. The alkylated melamine-formaldehyde copolymer and aryl compound substituted with at least one hydroxyl group may be polymerized at a weight ratio of about 1:0.05 to about 1:2, more specifically about 1:0.05 to about 1:0.5, or still more specifically about 1:0.1 to about 1:0.5. When an alkylated melamine-formaldehyde copolymer is reacted with an aryl compound substituted with at least one hydroxyl group within the foregoing weight ratio ranges, an aerogel with low density and improved mechanical strength may be provided.

The aerogel may be prepared by polymerizing a composition for producing an aerogel, which includes an alkylated melamine-formaldehyde copolymer or an alkylated melamine-formaldehyde copolymer and an aryl compound substituted with at least one hydroxyl group; and an organic solvent. As defined above, polymerizing includes forming a polymer, cross-linking, or both. Polymerizing provides a wet-gel, and then removing the organic solvent provides an aerogel.

Since the copolymerization of melamine and formaldehyde is performed in water as a solvent, subsequent drying processes for preparing an aerogel may take more time than if an organic solvent were used for polymerization. In addition, the formaldehyde used in the copolymerization reaction may raise the issue of disposing of toxic waste.

As disclosed herein, when the alkylated melamine-formaldehyde copolymer, or the alkylated melamine-formaldehyde copolymer and aryl compound substituted with at least one hydroxyl group, is used as a starting material in the polymerization reaction using an organic solvent, the polymerization and/or cross-linking may be performed quickly. Subsequent drying processes may also be faster than polymerization using water as a solvent. The organic solvent used for the polymerization may include an alcohol such as methanol, isopropanol, or the like. The organic solvent may also include organic solvents such as dimethyl formamide, acetone, 1,4-dioxane, tetrahydrofuran, dimethyl sulfoxide, toluene, benzene, dichlorobenzene, acetonitrile, N-methylpyrrolidine, or the like. A combination of organic solvents can be used.

In an embodiment the composition for producing an aerogel may include a catalyst. The catalyst may be used in an amount of about 0.1 parts by weight to about 20 parts by weight based on 100 parts by weight of the alkylated melamine-formaldehyde copolymer or alkylated melamine-formaldehyde copolymer and aryl compound substituted with at least one hydroxyl group used as a starting material.

To remove the organic solvent used in the polymerization, the prepared wet-gel may then undergo a solvent-exchange reaction. The solvent used in the solvent-exchange reaction is not particularly limited, as long as it has good compatibility with liquid carbon dioxide. Alternatively, the solvent exchange reaction may be omitted when the wet-gel is dried under high pressure or prepared using a solvent having good compatibility with carbon dioxide.

Next, the wet-gel is dried to provide an aerogel.

The drying may include, for example, supercritical drying, drying under high and reduced pressures, or a combination thereof.

The supercritical drying may be performed using supercritical carbon dioxide. First, liquid carbon dioxide is provided to a high pressure reactor to remove any solvent remaining in the wet-gel. Then, the carbon dioxide is slowly removed by increasing the temperature and the pressure beyond a threshold point. The supercritical drying can be performed at room temperature, and has excellent processability and safety.

Drying under high pressure is a common method of removing a solvent, and is performed by heating the wet-gel under high pressure, and it can be performed under atmospheric pressure. When a solvent is removed through drying under high pressure, a xerogel is prepared from an aerogel.

Drying under reduced pressure is a method of removing a solvent by freezing a wet-gel under reduced pressure and sublimating ice. When a solvent is removed through drying under reduced pressure, a cryogel is prepared from an aerogel.

The aerogel may have a density of about 0.2 g/cm³ or less, and in an embodiment, it may have a density of about 0.01 g/cm³ to 0.15 g/cm³. The aerogel may have porosity of about 70% or more, 80% or more, 90% or more, or 95% or more by volume and in an embodiment, the aerogel may have porosity of about 90% to about 98% by volume.

According to an embodiment, an aerogel composite includes a support including a plurality of micro-openings, and an aerogel derived from the polymer disposed in the micro-openings of the support.

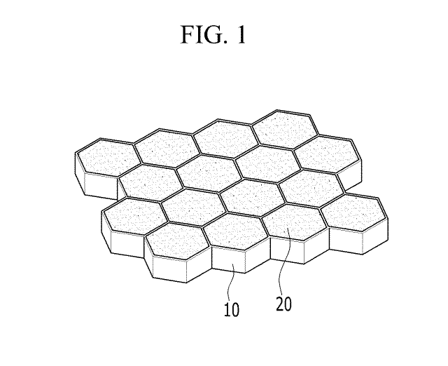

An aerogel composite according to an embodiment is illustrated in FIG. 1. FIG. 1 is a schematic diagram of an aerogel composite according to an embodiment. Referring to FIG. 1, according to an embodiment, an aerogel composite includes a support 10, and an aerogel 20 disposed in the micro-openings of the support 10.

The support 10 may include a polymer having a combination of properties suitable for the intended use of the aerogel composite, for example, melt temperature, tensile strength, compression strength, flexural strength, impact resistance, solvent resistance, heat resistance, hardness, adiabatic properties, and the like. The support may comprise a polymer selected from polyurethane, polyvinylchloride, polycarbonate, polyester, polymethyl(meth)acrylate, polyurea, polyether, polyisocyanurate, a melamine-formaldehyde copolymer, and a combination thereof. The polymer may be a melamine-formaldehyde copolymer. The melamine-formaldehyde copolymer has adiabatic properties and flame retardancy as well as excellent mechanical properties, making it difficult to break down or damage through external impact. Furthermore, the melamine-formaldehyde copolymer has excellent chemical resistance and solvent resistance and therefore does not readily decompose or highly expand or shrink when contacted by a solvent. In addition, when it contacts the solvent, it has an expansion ratio or shrinkage ratio of about 10% or less, specifically about 8% or less, more specifically about 6% or less or still more specifically about 5% or less.

The support 10 may be prepared by reacting monomers for a polymer in the presence of a foaming agent, or may include a commercially-available continuous foam. For example, a polyurethane support may be prepared by reacting a polyol with a monomer containing at least two isocyanate groups, in the presence of a foaming agent.

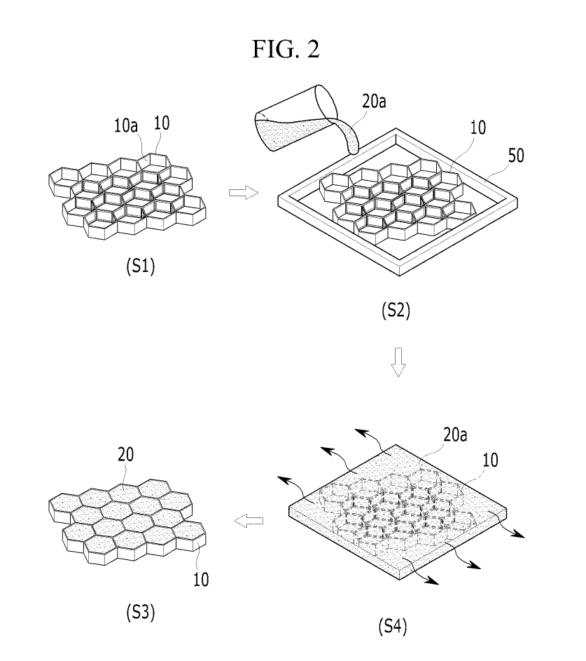

As illustrated in FIG. 2, the support 10 has a plurality of micro-openings 10a in the interior. Each of the micro-openings 10a may have a fine size wherein the average largest diameter of the micro-opening is about 300 micrometers (μm) or less, and may have a variety of irregular or regular shapes such as circular, oval, elliptical, polygonal, spherical, and the like. The shape of the micro-openings may be the same or different within a support.

A plurality of micro-openings 10a as illustrated in FIG. 2 may have a two-dimensional honeycomb or a three-dimensional mesh structure. The micro-openings need not be uniformly distributed, i.e., there may be areas in the support containing a lower or higher concentration or number of micro-openings. In an embodiment, the micro-openings are evenly distributed throughout the support. Adjacent micro-openings 10a may be open to each other, for example forming a continuous network of pores. In an embodiment the support may have a porosity of about 50% or more, about 70% or more, about 90% or more, about 95% or more, or about 98% or less. The aerogel composite may have density of about 0.2 g/cm³ or less, and in an embodiment, it may have density ranging from about 0.01 g/cm³ to about 0.15 g/cm³. In an embodiment, when the support 10 has a porosity and density within the ranges of about 90% to about 98% and about 0.01 g/cm³ to about 0.15 g/cm³ respectively, an aerogel composite may possess sufficient mechanical strength and flexibility for its intended use.

The polymer (the aerogel) 20 disposed in micro-openings of support 10 may be prepared by polymerizing an alkylated melamine-formaldehyde copolymer, or an alkylated melamine-formaldehyde copolymer and an aryl compound substituted with at least one hydroxyl group, as described above. The aerogel 20 has a plurality of pores with a size ranging from about 2 nanometers (nm) to about 50 nanometers (nm), and a porosity ranging from about 80% to about 99.9%, or more specifically, about 90% to about 99% by volume, based on the total volume of the aerogel 20.

A manufacturing method for the aerogel composite includes providing a support, wherein the support comprises a plurality of micro-openings; disposing a composition for producing an aerogel in the support wherein the composition comprises an organic solvent, polymerizing the disposed composition for preparing an aerogel in the support, to provide a polymer, and removing the solvent, to provide the aerogel composite.

Hereinafter, referring to FIG. 2, an embodiment of a method of preparing the aerogel composite is described.

FIG. 2 is a schematic diagram sequentially showing the method of preparing the aerogel composite according to an embodiment.

Referring to FIG. 2, the method of preparing the aerogel composite according to an embodiment may include providing a support 10 that includes a plurality of micro-openings 10a (S1), disposing, e.g., filling or impregnating a solution for preparing an aerogel 20a in the support 10 (S2), and removing the solvent from the support 10 containing the aerogel composition for producing the aerogel 20a (S4), to produce the aerogel composite (S3).

The support 10 may be prepared by reacting monomers for preparing a polymer using a foaming agent, or using a commercially-available continuous foam.

Next, the support 10 is placed into a vessel, e.g., a reaction tank 50 of a predetermined size as shown in FIG. 2 (S2). The micro-openings 10a of the support 10 are impregnated, filled, or otherwise contacted with a composition for producing an aerogel 20a. The composition for producing an aerogel 20a includes an alkylated melamine-formaldehyde copolymer, or an alkylated melamine-formaldehyde copolymer and an aryl compound substituted with at least one hydroxyl group. The composition for producing an aerogel 20a further comprises an organic solvent.

Next, the composition for producing an aerogel is polymerized in the organic solvent to provide a wet-gel. The polymerization reaction may include cross-linking, and is the same as described above.

The composition for producing an aerogel may further include a catalyst, and it is the same as described above.

Then, the prepared wet-gel may undergo an optional solvent exchange reaction using a solvent that has good compatibility with liquid carbon dioxide. Alternatively, the solvent exchange reaction may be omitted when the wet-gel is dried under high pressure or prepared using a solvent having good compatibility with liquid carbon dioxide.

Next, the wet-gel is dried by removing the solvent from the support 10 as shown in FIG. 2 (S4). The wet-gel may be dried through high pressure drying, reduced pressure drying, supercritical drying, or a combination thereof, which is the same as described above.

Next, the support 10 is taken out of the reaction tank 50, providing an aerogel composite including a support 10 with a plurality of micro-openings 10a filled with an aerogel 20, as shown in FIG. 2 (S3).

The aerogel composite may have density of about 0.2 g/cm³ or less, and in an embodiment, it may have density ranging from about 0.01 g/cm³ to about 0.15 g/cm³. The aerogel composite may have porosity of about 90% or more, and in an embodiment, it may have porosity of about 90% to about 98%.

Hereinafter, this disclosure is illustrated in more detail with reference to examples. However, they are exemplary embodiments of this disclosure and are not limiting.

Preparation of an Aerogel

### EXAMPLE 1

### Preparation of an Aerogel Using an Alkylated Melamine-Formaldehyde Copolymer

1.0 grams (“g”) of methylated poly(melamine-co-formaldehyde) (“PMFM”), 0.01 g (12 Molar) of hydrochloride (“HCl”) as a catalyst, and 10 mL of isopropyl alcohol as a solvent are added to a cylindrical polypropylene vial having a diameter of 3 centimeters (“cm”) and a height of 2 cm. The mixture is vigorously agitated to prepare an aerogel composition for producing an aerogel.

Then, the reaction temperature is slowly increased to 80° C. over 10 minutes, and a gel is identified by checking fluidity on the interface. Next, the prepared gel is matured under an increasing temperature, to provide a wet-gel.

The prepared wet-gel is exchanged with acetone, a solvent having good compatibility with liquid carbon dioxide. Then, the liquid carbon dioxide is provided to a high pressure reactor to remove the acetone inside the wet-gel. The acetone inside the wet-gel is removed by increasing the temperature and pressure beyond the threshold temperature of carbon dioxide and then slowly taking away the carbon dioxide at the same temperature by reducing the pressure, to provide an aerogel.

### EXAMPLES 2-4

### Preparation of an Aerogel Using an Alkylated Melamine-Formaldehyde Copolymer and a First Aryl Compound Substituted with at Least One Hydroxyl Group

Methylated poly(melamine-co-formaldehyde) (“PMFM”), resorcinol (“RES”), 0.01 g (12 Molar) of hydrochloride (HCl) as a catalyst, and 11 mL of isopropyl alcohol as a solvent are added to a cylindrical polypropylene vial having a diameter of 3 cm and a height of 2 cm. The mixture is vigorously agitated to prepare a composition for producing an aerogel. The methylated poly(melamine-co-formaldehyde) and resorcinol are used at a weight ratio described in Table 1. Then, the reaction temperature is slowly increased to 80° C. over 10 minutes, and a gel is identified by checking fluidity on the interface. Next, the prepared gel is matured at room temperature of about 80° C., preparing a wet-gel.

The prepared wet-gel is exchanged with acetone, a solvent having good compatibility with liquid carbon dioxide. Then, the liquid carbon dioxide is provided to a high pressure reactor to remove the acetone inside the wet-gel. The acetone inside the wet-gel is removed by increasing the temperature and pressure beyond the threshold temperature of carbon dioxide and then slowly taking away the carbon dioxide at the same temperature by reducing the pressure, to provide an aerogel.

### EXAMPLES 5-7

### Preparation of an Aerogel Using an Alkylated Melamine-Formaldehyde Copolymer and an Aryl Compound Substituted with at Least One Hydroxyl Group

An aerogel is prepared using phloroglucinol (“THB”) at an amount described in Table 1 instead of resorcinol.

The linear shrinkage ratios of the prepared aerogels according to Examples 2 through 7 may be calculated referring to Equation 1 and shown in the following Table 1.

[(diameter of wet-gel−diameter of aerogel)/diameter of wet-gel]×100 Equation 1

TABLE 1

| | | Linear shrinkage |
|---|---|---|
| Examples | Weight ratio | ratio (%) |
| 2 | PMFM:RES = 1:0.05 | 32.1 |
| 3 | PMFM:RES = 1:0.1 | 26.1 |
| 4 | PMFM:RES = 1:0.3 | 22.0 |
| 5 | PMFM:THB = 1:0.1 | 25.2 |
| 6 | PMFM:THB = 1:0.2 | 15.8 |
| 7 | PMFM:THB = 1:0.3 | 14.4 |

Further, specific surface areas (square meters per gram (“m²/g”) of the aerogels prepared according to Examples 2 through 6 are measured using a BET method, and are shown in the following Table 2.

TABLE 2

| | | Specific surface |
|---|---|---|
| Examples | Weight ratio | area (m²/g) |
| 2 | PMFM:RES = 1:0.05 | 475.74 |
| 3 | PMFM:RES = 1:0.1 | 519.07 |
| 4 | PMFM:RES = 1:0.3 | 403.26 |
| 5 | PMFM:THB = 1:0.1 | 779.12 |
| 6 | PMFM:THB = 1:0.2 | 353.59 |

Referring to Tables 1 and 2, the aerogels of Examples 2 through 6 have low linear shrinkage, and the aerogels of Examples 2 through 6 have large specific surface areas.

In order to measure density and thermal conductivity, the compositions for producing an aerogel according to Examples 1, 2, and 6 are added to large vials to prepare aerogels. The linear shrinkage, density, and thermal conductivity of the prepared aerogels are measured, and are shown in the following Table 3. The linear shrinkage ratio is calculated referring to Equation 1, and the thermal conductivity is measured by a thermal conductivity tester (heat flow meter, “HFM”).

TABLE 3

| | Linear | | Thermal |
|---|---|---|---|
| | shrinkage | | conductivity |
| Examples | ratio (LS) | Density (D) | (TC) |
| Example 1 | 20.0% | 0.13 g/cm³ | 16.6 mW/m · K |
| Example 2 | 12.9% | 0.11 g/cm³ | 16.2 mW/m · K |
| Example 6 | 11.4% | 0.12 g/cm³ | 16.1 mW/m · K |

LS: linear shrinkage ratio, D: density (grams per cubic centimeter (g/cm³)), TC: thermal conductivity (at 293K) (milliwatts per meter Kelvin (mW/mK))

Referring to Table 3, the aerogels according to Examples 1, 2, and 6 have excellent linear shrinkage, density, and thermal conductivity.

Preparation of Aerogel Composite

### EXAMPLE 8

### Preparation of an Aerogel Composite Using Alkylated Melamine-Formaldehyde Copolymer

1.0 g of methylated poly(melamine-co-formaldehyde) (“PMFM”), 0.01 g (12 Molar) of hydrochloride (“HCl”) as a catalyst, and 10 mL of isopropyl alcohol as a solvent are added to a cylindrical polypropylene vial having a diameter of 3 cm and a height of 2 cm. The mixture is vigorously agitated to prepare a composition for an aerogel.

The composition for an aerogel is impregnated in a support (BASOTECT®, a melamine foam, manufactured by BASF).

Then, the reaction temperature is slowly increased to 80° C. over 10 minutes, and a gel is identified by checking fluidity on the interface. Next, the prepared gel is matured under an increasing temperature, preparing a wet-gel.

The prepared wet-gel is exchanged with acetone, a solvent having good compatibility with liquid carbon dioxide. Then, the liquid carbon dioxide is provided to a high pressure reactor to remove the acetone inside the wet-gel. The acetone inside the wet-gel is removed by increasing the temperature and pressure beyond the threshold temperature of carbon dioxide and then slowly taking away the carbon dioxide at the same temperature by reducing the pressure, to provide an aerogel composite.

### EXAMPLE 9

### Preparation of an Aerogel Composite Using Alkylated Melamine-Formaldehyde Copolymer and an Aryl Compound Substituted with at Least One Hydroxyl Group

Methylated poly(melamine-co-formaldehyde) (“PMFM”), phloroglucinol, 0.01 g (12 Molar) of hydrochloride (HCl) as a catalyst, and 11 mL of isopropyl alcohol as a solvent are added to a cylindrical polypropylene vial having a diameter of 3 cm and a height of 2 cm. The mixture is vigorously agitated to prepare a composition for an aerogel. The methylated poly(melamine-co-formaldehyde) and phloroglucinol are used at a weight ratio of 1:0.1.

The composition for an aerogel is impregnated in a support (BASOTECT®, a melamine foam manufactured by BASF). Then, an aerogel composite is prepared by the same method as Example 8.

### EXAMPLE 10

### Preparation of an Aerogel Composite Using Alkylated Melamine-Formaldehyde Copolymer and an Aryl Compound Substituted with at Least One Hydroxyl Group

Methylated poly(melamine-co-formaldehyde) (“PMFM”), resorcinol, 0.01 g (12 Molar) of hydrochloride (“HCl”) as a catalyst, and 11 mL of isopropyl alcohol as a solvent are added to a cylindrical polypropylene vial having a diameter of 3 cm and a height of 2 cm. The mixture is vigorously agitated to prepare a composition for an aerogel. The methylated poly(melamine-co-formaldehyde) and resorcinol are used at a weight ratio of 1:0.1.

The composition for an aerogel is impregnated in a support (BASOTECT®, a melamine foam manufactured by BASF). Then, an aerogel composite is prepared by the same method as Example 8.

The linear shrinkage, density, and thermal conductivity of the prepared aerogel composites according to Examples 8 through 10 are measured, and are shown in the following Table 4. The linear shrinkage ratio is calculated referring to Equation 1, and the thermal conductivity is measured by a thermal conductivity tester (heat flow meter, “HFM”).

TABLE 4

| | Linear | | Compression | Thermal |
|---|---|---|---|---|
| | shrinkage | | strength | Conductivity |
| Example | ratio | Density (D) | (MPa) | (TC) |
| Example 8 | 20% | 0.13 g/cm³ | 80.5 | 16.6 mW/m · K |
| Example 9 | 11.4% | 0.12 g/cm³ | 65.6 | 16.1 mW/m · K |
| Example 10 | 16% | 0.12 g/cm³ | 70.8 | 15.8 mW/m · K |

Referring to Table 4, the aerogel composites according to Examples 8, 9, and 10 have maintained low linear shrinkage, density, and thermal conductivity, and have improved compression strength.

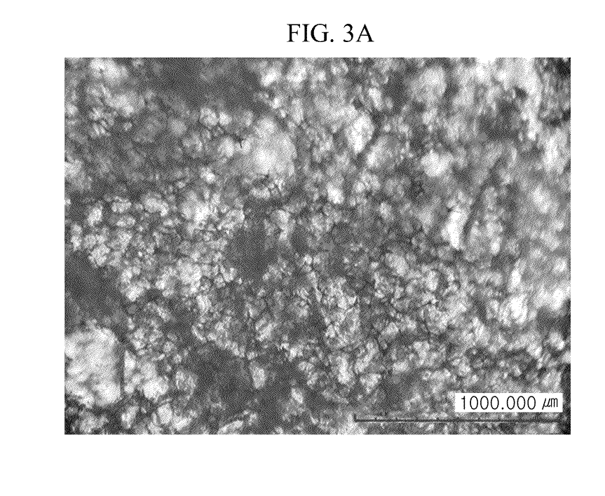

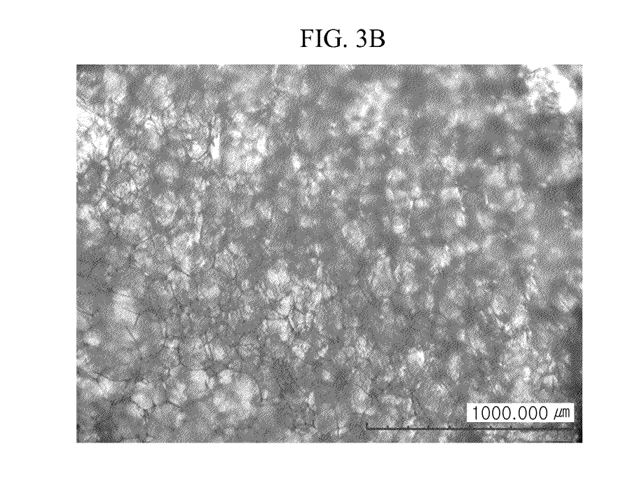

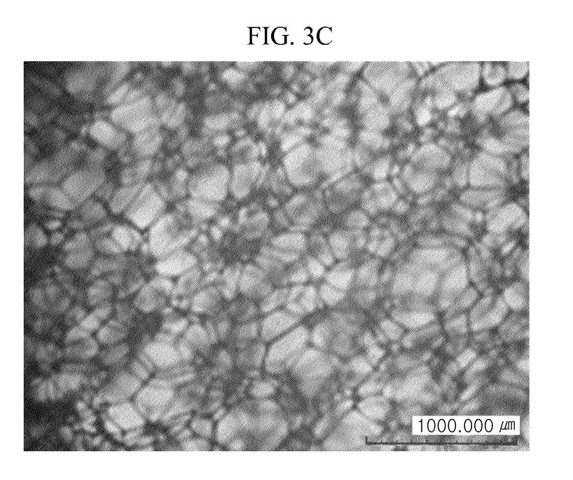

FIGS. 3A and 3B are optical microscope photographs of the aerogel composite according to Examples 8 and 9. An optical microscope photograph of a support is provided for comparison in FIG. 3C. As shown in FIGS. 3A and 3B, the micro-openings of the support are filled with a cross-linked polymer.

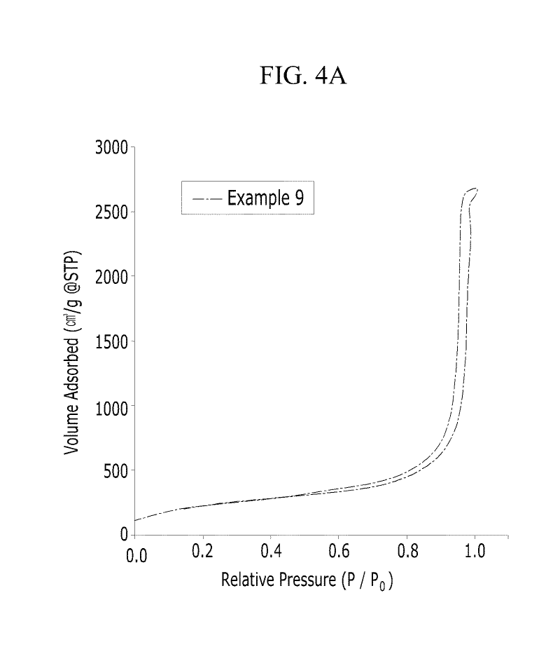

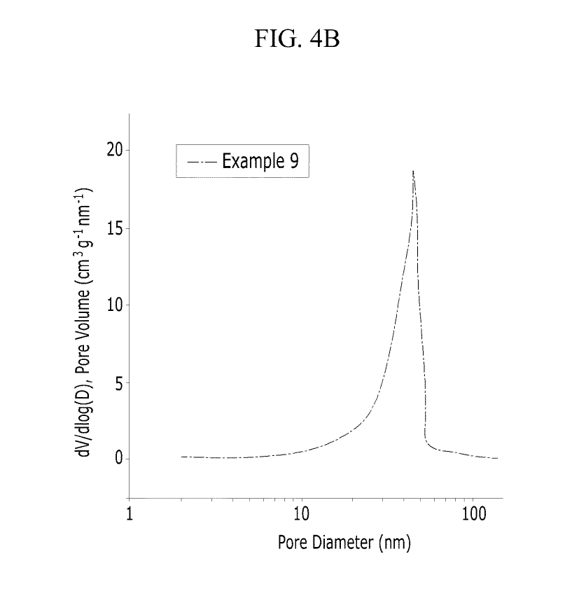

FIG. 4A shows a nitrogen (N₂) adsorption-desorption isotherm of the aerogel composite according to Example 9. FIG. 4B shows a pore distribution calculated from this N₂ adsorption-desorption isotherm.

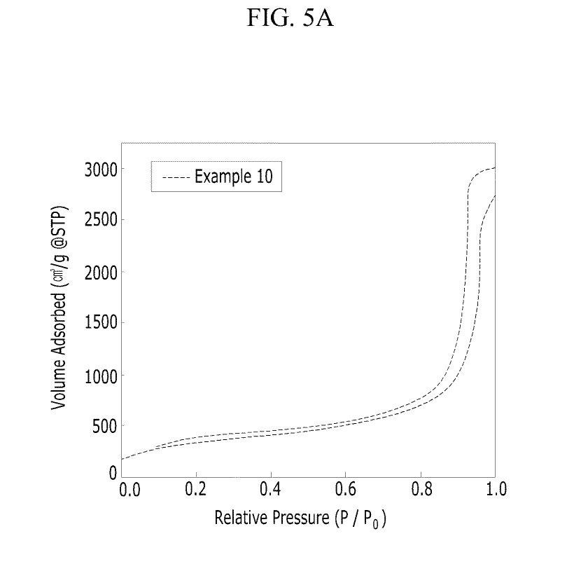

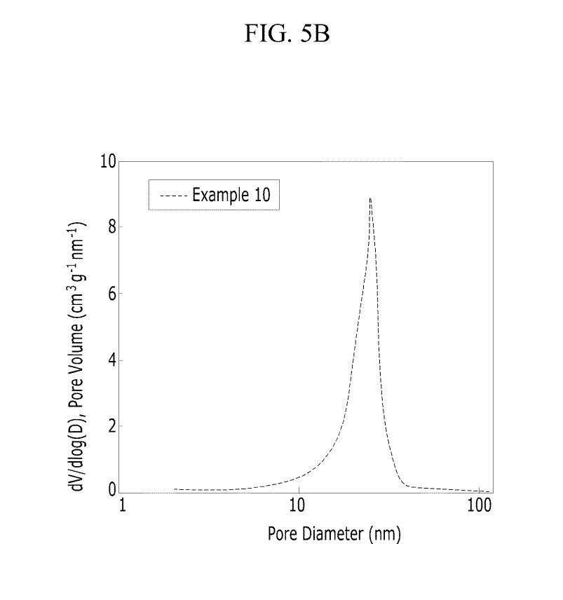

FIG. 5A shows a nitrogen adsorption-desorption isotherm of the aerogel composite according to Example 10, and FIG. 5B shows a pore distribution calculated therefrom.

Referring to FIGS. 4A and 5A, the aerogel composites according to Examples 9 and 10 have nitrogen adsorption or desorption amounts that change depending on pressure. Accordingly, the aerogel composites are identified as having fine pores. In addition, FIGS. 4B and 5B show that the pores are uniformly distributed.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An aerogel comprising
a polymerization product of an alkylated melamine-formaldehyde copolymer; or of an alkylated melamine-formaldehyde copolymer and an aryl compound substituted with at least one hydroxyl group.

2. The aerogel of claim 1, wherein the alkylated melamine-formaldehyde copolymer comprises a repeating unit represented by the following Chemical Formula 1: 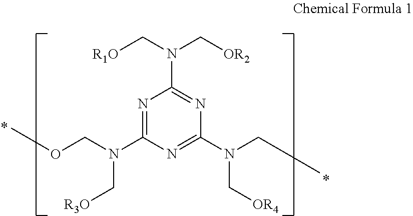
wherein, in Chemical Formula 1, R₁ to R₄ are each independently hydrogen or an alkyl group, and at least one of R₁ to R₄ is an alkyl group.

3. The aerogel of claim 2, wherein the alkyl group is a C1 to C10 alkyl group.

4. The aerogel of claim 1, wherein the aryl compound substituted with at least one hydroxyl group is selected from a dihydroxybenzene substituted with 0-3 C1 to C3 alkyl groups, phenol, a phenol substituted with 0-3 C1 to C3 alkyl groups, a trihydroxy benzene substituted with 0-3 C1 to C3 alkyl groups, and a polyphenol.

5. The aerogel of claim 1, wherein the alkylated melamine-formaldehyde copolymer has a number average molecular weight of about 10 Daltons to about 1000 Daltons.

6. The aerogel of claim 1, wherein the alkylated melamine-formaldehyde copolymer and aryl compound substituted with at least one hydroxyl group are polymerized at a weight ratio of about 1:0.01 to about 1:5.

7. The aerogel of claim 6, wherein the alkylated melamine-formaldehyde copolymer and aryl compound substituted with at least one hydroxyl group are polymerized at a weight ratio of about 1:0.05 to about 1:0.5.

8. A composition for producing an aerogel, comprising:
an alkylated melamine-formaldehyde copolymer, or
an alkylated melamine-formaldehyde copolymer and an aryl compound substituted with at least one hydroxyl group; and
an organic solvent.

9. The composition for producing an aerogel of claim 8, wherein the alkylated melamine-formaldehyde copolymer comprises a repeating unit represented by the following Chemical Formula 1: 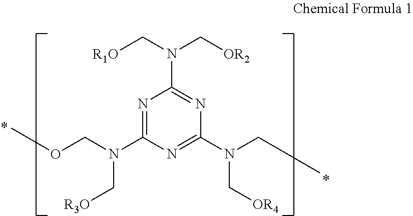
wherein, in Chemical Formula 1,
R₁ to R₄ are each independently hydrogen or an alkyl group, and at least one of R₁ to R₄ is an alkyl group.

10. The composition for producing an aerogel of claim 9, wherein the alkyl group is a C1 to C10 alkyl group.

11. The composition for producing an aerogel of claim 8, wherein the aryl compound substituted with at least one hydroxyl group is selected from a dihydroxybenzene substituted with 0-3 C1 to C3 alkyl groups, phenol, a phenol substituted with 0-3 C1 to C3 alkyl groups, a trihydroxy benzene substituted with 0-3 C1 to C3 alkyl groups, and a polyphenol.

12. The composition for producing an aerogel of claim 8, wherein the alkylated melamine-formaldehyde copolymer has a number average molecular weight of about 10 Daltons to about 1000 Daltons.

13. The composition for producing an aerogel of claim 8, comprising the alkylated melamine-formaldehyde copolymer and the aryl compound substituted with at least one hydroxyl group are present at a weight ratio ranging from about 1:0.01 to about 1:5.

14. The composition for producing an aerogel of claim 13, wherein the alkylated melamine-formaldehyde copolymer and the aryl compound substituted with at least one hydroxyl group are present at a weight ratio ranging from about 1:0.05 to about 1:0.5.

15. An aerogel composite, comprising:
a support comprising a plurality of micro-openings; and
an aerogel disposed in the micro-openings,
wherein the aerogel is a polymerization product of an alkylated melamine-formaldehyde copolymer or a polymerization product of an alkylated melamine-formaldehyde copolymer and an aryl compound substituted with at least one hydroxyl group.

16. The aerogel composite of claim 15, wherein the alkylated melamine-formaldehyde copolymer has a repeating unit represented by the following Chemical Formula 1: 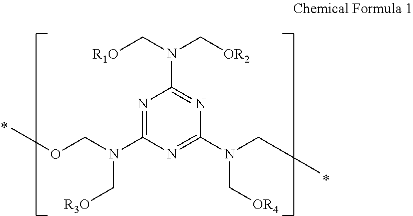
wherein, in Chemical Formula 1,
R₁ to R₄ are each independently hydrogen or an alkyl group, and at least one of R₁ to R₄ is an alkyl group.

17. The aerogel composite of claim 15, wherein the alkylated melamine-formaldehyde copolymer has a number average molecular weight ranging from about 10 Daltons to about 1000 Daltons.

18. The aerogel composite of claim 15, wherein the alkylated melamine-formaldehyde copolymer is polymerized with an aryl compound substituted with at least one hydroxyl group at a weight ratio ranging from about 1:0.01 to about 1:5.

19. The aerogel composite of claim 15, wherein the support is selected from polyurethane, polyvinylchloride, polycarbonate, polyester, polymethyl(meth)acrylate, polyurea, polyether, polyisocyanurate, a melamine-formaldehyde copolymer, and a combination thereof.

20. The aerogel composite of claim 15, wherein the plurality of micro-openings each has an average largest diameter of about 300 micrometer or less.

21. The aerogel composite of claim 15, wherein the support has a two-dimensional honeycomb structure or a three-dimensional mesh structure.

22. The aerogel composite of claim 15, wherein the support has an expansion ratio or a contraction ratio of 10% or less when it contacts a solvent.

23. The aerogel composite of claim 15, wherein the aerogel composite has density of about 0.2 grams per cubic centimeter or less.

24. The aerogel composite of claim 15, wherein the aerogel composite has a porosity of more than about 90%.

25. A method of manufacturing an aerogel, comprising
polymerizing a composition for producing an aerogel according to claim 8 in an organic solvent; and
removing the organic solvent to form the aerogel.

26. A method of manufacturing an aerogel composite comprising:
providing a support comprising a plurality of micro-openings;
disposing a composition for producing an aerogel according to claim 8 in the support;
polymerizing the disposed composition for producing an aerogel; and
removing the solvent from the support to produce the aerogel composite.
